(19) United States
(12) Patent Application Publication
(10) Pub. No.: US 2026/0092614 A1
(43) Pub. Date: Apr. 2, 2026

(54) TOOL-LESS, HANDS-ON MOUNTING SYSTEM FOR QUICK CHANGEOVER IN METAL FORMING MACHINES

(71) Applicant: New Tech Machinery International Corp, Aurora, CO (US)

(72) Inventor: Bryan Michael Yancy, Dallas, GA (US)

(21) Appl. No.: 19/347,847

(22) Filed: Oct. 2, 2025

Related U.S. Application Data
(60) Provisional application No. 63/702,600, filed on Oct. 2, 2024.
(60) Provisional application No. 63/702,606, filed on Oct. 2, 2024.
(60) Provisional application No. 63/702,608, filed on Oct. 2, 2024.

(51) Int. Cl. F16B 2/18; F16B 21/09

(52) U.S. Cl. CPC F16B 2/185; F16B 21/09; F16B 2200/40

(57) ABSTRACT

A tool-less assembly includes a tooling apparatus including a support plate defining a support opening that extends through the support plate, a base plate including a base opening that extends through the base plate, and an attachment apparatus extending through the support opening and the base opening. The attachment apparatus includes a handle that moves between an opened position and a closed position, a fastener attached to the handle and extending through the support opening and the base opening, and an anchor attached to the fastener.

### CROSS-REFERENCE TO RELATED APPLICATIONS

The present application claims priority to U.S. Provisional Patent Application No. 63/702,600, filed on October 2, 2024, and titled “TOOL-LESS, HANDS-ON MOUNTING SYSTEM FOR QUICK CHANGEOVER IN METAL FORMING MACHINES,” further claims priority to U.S. Provisional Patent Application No. 63/702,606, filed on October 2, 2024, and titled “TOOL-LESS, HANDS-ON MOUNTING SYSTEM FOR QUICK CHANGEOVER IN METAL FORMING MACHINES,” and further claims priority to U.S. Provisional Patent Application No. 63/702,608, filed on October 2, 2024, and titled “TOOL-LESS, HANDS-ON MOUNTING SYSTEM FOR QUICK CHANGEOVER IN METAL FORMING MACHINES,” the entire contents of these disclosures are incorporated herein by reference in their entirety.

### FIELD

The present disclosure relates generally to a tool-less assembly for attaching a tooling apparatus to a base plate.

### BACKGROUND

It is known to permanently affix a tooling apparatus to a base plate. However, permanently affixing the tooling apparatus to the base plate reduces adaptability and the ability to replace parts.

### SUMMARY

The following presents a simplified summary of the disclosure to provide a basic understanding of some aspects described in the detailed description.

In aspects, a tool-less assembly comprises a tooling apparatus comprising a support plate defining a support opening that extends through the support plate, a base plate comprising a base opening that extends through the base plate, wherein the base opening comprises a first opening portion and a second opening portion that are adjacent, and connected, to one another, the first opening portion having a first cross-sectional size that is larger than a second cross-sectional size of the second opening portion, and an attachment apparatus extending through the support opening and the base opening, the attachment apparatus comprises a handle that is configured to move between an opened position and a closed position, a fastener attached to the handle and extending through the support opening and the base opening, and an anchor attached to the fastener and having an anchor cross-sectional size that is smaller than the first cross-sectional size and larger than the second cross-sectional size, wherein the support plate and the base plate are positioned between the handle and the anchor with the fastener extending through the second opening portion, and the handle and the anchor configured to apply a compressive force to the support plate and the base plate.

In aspects, a tool-less assembly comprises a tooling apparatus comprising a support plate defining a support opening that extends through the support plate, a base plate comprising a base opening that extends through the base plate, and an attachment apparatus extending through the support opening and the base opening. The attachment apparatus comprises a handle that is configured to move between an opened position and a closed position, a fastener attached to the handle and extending through the support opening and the base opening, a contact plate configured to move relative to the fastener, an anchor attached to the fastener and spaced apart from the contact plate, wherein when the handle is in the opened position, the contact plate is separated a first separating distance from the anchor, and when the handle is in the closed position, the contact plate is separated a second separating distance, which is less than the first separating distance, from the anchor, and the contact plate and the anchor are configured to apply a compressive force to the support plate and the base plate.

In aspects, a tool-less assembly comprises an attachment apparatus configured to attach a tooling apparatus to a base plate by extending through openings in the tooling apparatus and the base plate, the attachment apparatus comprises a handle that is configured to move between an opened position and a closed position, a fastener attached to the handle and extending through the support opening and the base opening, a contact plate configured to move relative to the fastener, and an anchor attached to the fastener and spaced apart from the contact plate, wherein when the handle is in the opened position, the contact plate is separated a first separating distance from the anchor, and when the handle is in the closed position, the contact plate is separated a second separating distance, which is less than the first separating distance, from the anchor, and the contact plate and the anchor are configured to apply a compressive force to the support plate and the base plate.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates a tool-less assembly in accordance with aspects of the disclosure;

FIG. 2 schematically illustrates a tool-less assembly in accordance with aspects of the disclosure;

FIG. 3 schematically illustrates a tool-less assembly in accordance with aspects of the disclosure;

FIG. 4 schematically illustrates a tool-less assembly in accordance with aspects of the disclosure;

FIG. 5 schematically illustrates a tool-less assembly in accordance with aspects of the disclosure;

FIG. 6 schematically illustrates a tool-less assembly in accordance with aspects of the disclosure;

FIG. 7 schematically illustrates a tool-less assembly in accordance with aspects of the disclosure;

FIG. 8 schematically illustrates a tool-less assembly in accordance with aspects of the disclosure;

FIG. 9 schematically illustrates a tool-less assembly in accordance with aspects of the disclosure; and

FIG. 10 schematically illustrates a tool-less assembly in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein – for example up, down, right, left, front, back, top, bottom, upper, lower, etc. - are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic relative to arrangement of steps, operational flow, order of components, or orientation of components; plain meaning derived from grammatical organization or punctuation, and; the number or type of aspects described in the specification.

As used herein, the singular forms "a," "an," and "the" include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising,” “including,” and variations thereof shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

Unless otherwise indicated, the terms “distal” and “proximal” are used in the following description with respect to a position or direction relative to the treating clinician. “Distal” and “distally” are positions distant from or in a direction away from the clinician, and “proximal” and “proximally” are positions near or in a direction toward the clinician.

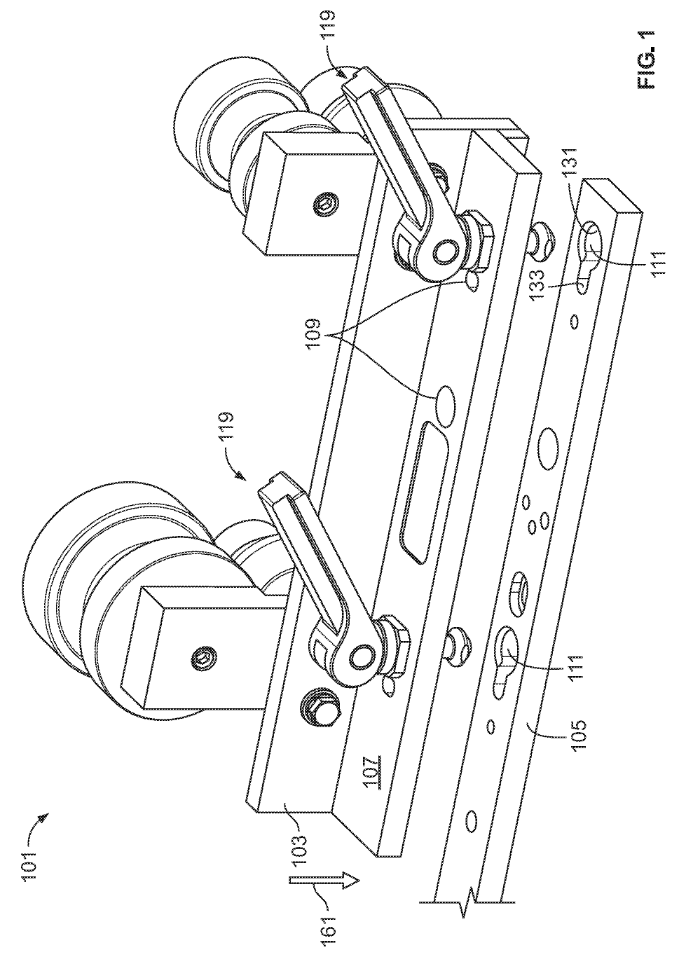

FIG. 1 illustrates a tool-less assembly 101, hereinafter, assembly 101. The assembly 101 may comprise a plurality of structures that may comprise a tooling apparatus 103, a base plate 105, and one or more structures that facilitate the removable attachment of the tooling apparatus 103 to the base plate 105. The tooling apparatus 103 may comprise, for example, a support plate 107 through which one or more support openings 109 may extend, for example, with the support openings 109 extending from an upper surface to a lower surface of the support plate 107. The support plate 107 may have a substantially planar shape and may extend linearly along an axis. FIG. 1 illustrates a possible example of the support plate 107, however, in other embodiments, additional configurations of the support plate 107 are possible. In embodiments, one or more tooling structures may be attached to the support plate 107.

The base plate 105 may have a substantially planar shape and may extend linearly along an axis that is parallel to the axis along which the support plate 107 extends. The base plate 105 may comprise one or more base openings 111 extending through the base plate 105, for example, from an upper surface to a lower surface of the base plate 105. In embodiments, the base plate 105 may be positioned adjacent to the support plate 107 such that an upper surface of the base plate 105 may be in contact with a lower surface of the support plate 107. The base plate 105 and the support plate 107 may be aligned relative to one another such that one or more of the support openings 109 of the support plate 107 may be aligned with one or more of the base openings 111 of the base plate 105. As with the tooling apparatus 103, the base plate 105 is not limited to the illustrated shape and configuration. Rather, in other embodiments, additional configurations of the base plate 105 are possible. Though not illustrated, the base plate 105 may be attached to an additional machine structure.

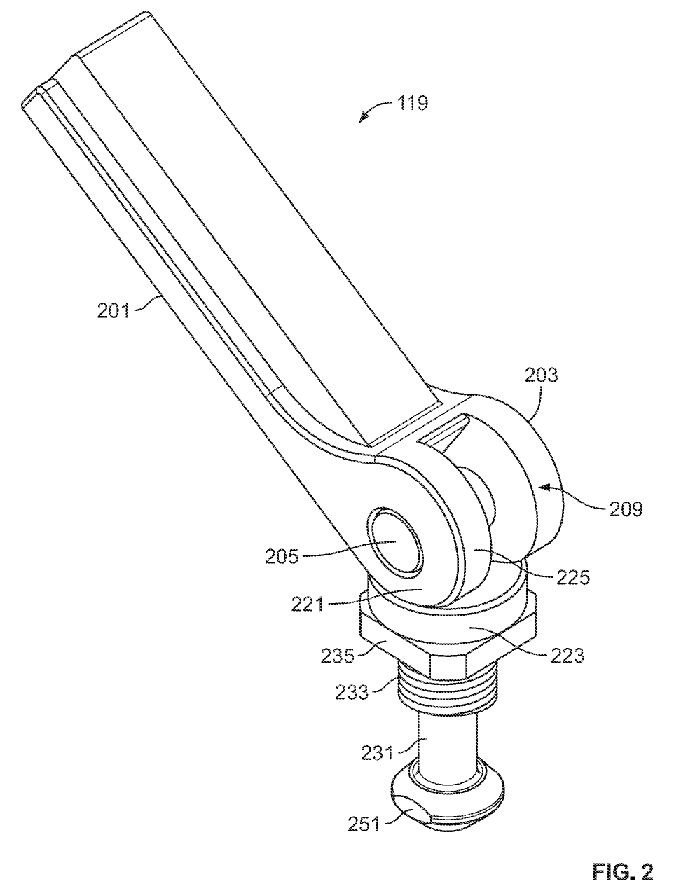

The assembly 101 may comprise an attachment apparatus 119 that may attach the tooling apparatus 103 to the base plate 105. The attachment apparatus 119 is illustrated in an unlocked position in FIG. 1. To further illustrate portions of the attachment apparatus 119, reference is made to FIG. 2, which illustrates the attachment apparatus 119 without the tooling apparatus 103 and the base plate 105 such that features of the attachment apparatus 119 are not obstructed from view.

The attachment apparatus 119 may comprise a handle 201 that may be grasped, held, or otherwise manipulated by an operator, employee, etc. The handle 201 may be elongated and may comprise an attachment portion 203. For example, the handle 201 may be attached to, or formed with, the attachment portion 203 such that movement and rotation of the handle 201 can cause a corresponding movement or rotation of the attachment portion 203. The attachment portion 203 may comprise a rounded shaft opening that is sized to receive a shaft 205 relative to which the attachment portion 203 and the handle 201 may pivot (e.g., with the handle 201 moving by rotating about the shaft 205 between the opened position and the closed position). For example, the shaft 205 may extend along an axis that is perpendicular to a direction along which the handle 201 extends. The handle 201 may move (e.g., pivot, rotate) between the opened position and the closed position. Though not required, the attachment portion 203 may comprise a pair of spaced apart extension portions that define a gap, space, or channel therebetween, and the extension portions may be parallel to one another and may each comprise the rounded or circular shape. The attachment portion 203 may receive the fastener 231 within the space between the extension portions, and the shaft 205 may extend through openings in the extension portions, for example, by extending from one extension portion to another extension portion and through the gap between the extension portions.

The attachment portion 203 may pivot relative to the shaft 205, for example, by rotating about the shaft 205. In embodiments, the attachment portion 203 may comprise a rounded or curved outer surface 209 such that the attachment portion 203 has a rounded shape that circumferentially surrounds the shaft 205. The outer surface 209 may be spaced a non-constant distance from the shaft 205. For example, when the attachment apparatus 119 is in the opened (or unlocked) position (e.g., illustrated in FIG. 2), a first portion 221 of the attachment portion 203 may be in contact with a support plate 223 that is positioned below the attachment portion 203. The first portion 221 may be spaced a first distance 301 from the shaft 205 (e.g., wherein the first distance 301 is between the shaft 205 and the outer surface of the attachment portion 203 at the first portion 221) while a second portion 225 may be spaced a second distance 303 from the shaft 205 (e.g., wherein the second distance 303 is between the shaft 205 and the outer surface of the attachment portion 203 at the second portion 225). The first distance 301 may be measured in, and extend in, a first radial direction, while the second distance 305 may be measured in, and extend in, a second radial direction.

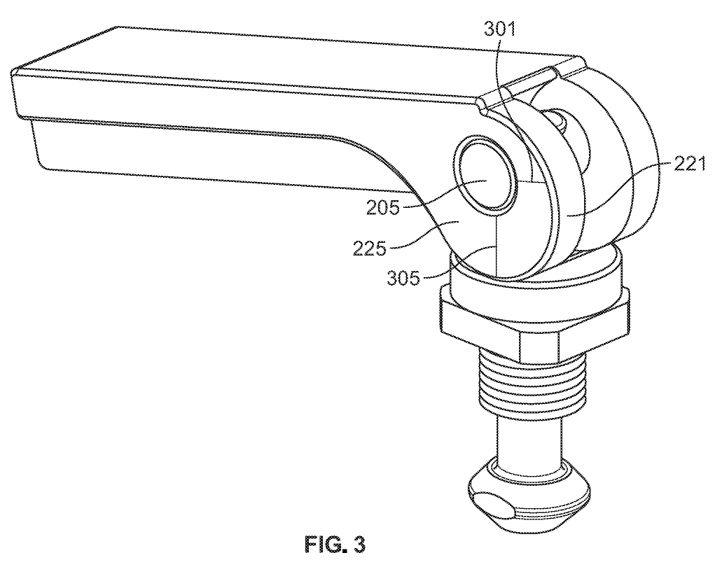

The first portion 221 and the second portion 225 may be circumferentially offset from one another about the shaft 205, for example, with an angle of between about 60 degrees to 120 degrees separating the first portion 221 from the second portion 225. As illustrated in FIG. 3, when the attachment apparatus 119 is in a closed (or locked) position, the second portion 225 of the attachment portion 203 may be in contact with the support plate 223. The first distance 301 from the shaft 205 to an outer surface of the first portion 221 may be less than the second distance 305 from the shaft 205 to an outer surface of the second portion 225. As such, as the handle 201 is rotated from the opened position to the closed position, the attachment portion 203 may rotate relative to the shaft 205. This rotation of the attachment portion 203 can cause the first portion 221 to no longer be in contact with the support plate 223, but, rather, may cause the second portion 225 to be in contact with the support plate 223. In particular, the outer surface 209 of the attachment portion 203 may move (e.g., pivot, rotate, etc.) relative to the support plate 223 as the handle 201 is rotated in a clockwise or counter-clockwise direction. Due to the differing dimensions or diameters of the first portion 221 (e.g., first distance 225) and the second portion 225 (e.g., second distance 301), the second portion 225 may contact the support plate 223 and bias the support plate 223 in a downward direction away from the shaft 205 and/or may bias the handle 201 and shaft 205 in a direction upwardly away from the support plate 223. Accordingly, the first portion 221 may face the contact plate 235 and the anchor 251 when the handle 201 is in the opened position of FIG. 2, and the second portion 225 may face the contact plate 235 and the anchor 251 when the handle 201 is in the closed position of FIG. 3.

The shaft 205 may be attached to a fastener 231, for example, a screw or a bolt, that extends along a linear axis and is attached to the shaft 205. For example, an upper end of the fastener 231 may be attached to the shaft 205 in several ways, for example, by threading into the shaft 205 (e.g., with the upper end of the fastener 231 comprise a threaded region that engages and mates with a corresponding threaded region or opening of the shaft 205), by being welded to the shaft 205, by being adhered with an adhesive to the shaft 205, by being unitarily formed as a single piece or structure with the shaft 205, etc. A threaded portion 233 may circumferentially surround the fastener 231, with the threaded portion 233 positioned below the support plate 223 and below a contact plate 235. In embodiments, the contact plate 235 may be positioned below the support plate 223, with the contact plate 235 between the threaded portion 233 and the support plate 223. In embodiments, the threaded portion 233 may be threaded into the support opening 109, which may have a matching thread to mate with the threaded portion 233. In this way, the threaded portion 233 may function to position the attachment apparatus 119 relative to the support opening 109, while the anchor 251, the fastener 231, the contact plate 235, the support plate 223, etc. may move in an axial direction relative to the threaded portion 233 and the support opening 109. In particular, the anchor 251, the fastener 231, the contact plate 235, the support plate 223, etc. are not fixedly attached to the threaded portion 233, and may move freely relative to the threaded portion 233 as described herein. In aspects, the attachment apparatus 119 is not limited to comprising the threaded portion 233, and, instead, may comprise an enlarged region (e.g., that is not threaded) that has a cross-sectional size that is similar or matching the cross-sectional size of the support opening 109, in which case the enlarged region may be inserted, press-fit, or otherwise fixedly attached within the support opening 109.

It will be appreciated that while the support plate 223 and the contact plate 235 are illustrated herein as two separate structures the support plate 223 and the contact plate 235 may be a single structure, for example, a single contact plate, that functions in an identical manner as the support plate 223 and the contact plate 235. For example, a single contact plate may be provided in the attachment apparatus 119, with the single contact plate replacing the support plate 223 and the contact plate 235, and the single contact plate being in the same location, and functioning the same way, as the support plate 223 and the contact plate 235.

The contact plate 235 may be attached to the fastener 231 such that the contact plate 235 may not be inadvertently detached or removed from the fastener 231. However, the contact plate 235 is movable relative to the fastener 231, for example, by being movable in an axial direction relative to the fastener 231. In aspects, the contact plate 235 may have an opening through which the fastener 231 is received, such that the contact plate 235 can slide (e.g., upwardly and downwardly) relative to the fastener 231. The contact plate 235 can move, relative to the fastener 231, in a direction toward and away from the anchor 251, such that the contact plate 235 and the anchor 251 may be spaced apart by a first separating distance (e.g., when the handle 201 is in the opened position) and a second separating distance (e.g., when the handle 201 is in the closed position), with the second separating distance being less than the first separating distance.

As illustrated in FIG. 1, the contact plate 235 may be in contact with, and may rest on top of, the support plate 107. As will be described below, rotation of the handle 201 may cause the attachment portion 203 and the shaft 205 to move upwardly and away from the contact plate 235, wherein this upward movement of the attachment portion 203 and the shaft 205 may cause the fastener 231 to move upwardly with the attachment portion 203 and the shaft 205. The fastener 231 may comprise an anchor 251 at a lower end of the fastener 231, with the anchor 251 spaced a distance apart from the contact plate 235. Upward movement of the fastener 231 may likewise cause the anchor 251 to move upwardly toward the contact plate 235 and the support plate 223. The fastener 231 may therefore be attached to the handle 201, for example, with the fastener 231 attached to the shaft 205, the shaft 205 being attached to the attachment portion 203, and the attachment portion 203 being attached to the handle 201. The anchor 251 may have an anchor cross-sectional size that is less than a first cross-sectional size of the first opening portion 131 and larger than a second cross-sectional size of the second opening portion 133. The fastener 231 may have a fastener cross-sectional size that is less than the anchor cross-sectional size.

FIG. 3 illustrates the attachment apparatus 119 after being rotated from the opened position (e.g., illustrated in FIG. 2) to the closed position (e.g., illustrated in FIG. 3). The attachment apparatus 119 may be rotated in response to an operator or employee grasping the attachment apparatus 119 and rotating the handle 201 of the attachment apparatus 119. Though not required, in aspects, the handle 201 may be in a substantially horizontal position that is perpendicular to the fastener 231 in the closed position. In the opened position, the handle 201 may extend along an axis that is not perpendicular to the fastener 231. By moving from the opened position to the closed position, the shaft 205 and the handle 201 may move in an upward direction away from the support plate 223, due to the greater separating second distance 305 from the shaft 205 to the second portion 225 as compared to the separating first distance 301 from the shaft 205 to the first portion 221. This movement of the shaft 205 and the handle 201 in the upward direction in FIG. 3 may cause the fastener 231 and the anchor 251 to also move upwardly toward the contact plate 235, thus reducing the distance between the anchor 251 and the contact plate 235.

In operation, and with reference to FIG. 1, the attachment apparatus 119 can be positioned at least partially within one of the support openings 109 of the tooling apparatus 103. For example, the fastener 231 and the anchor 251 may be positioned to extend through one of the support openings 109, such that the anchor 251 may be positioned on a bottom side of the support plate 107 and the remaining portions of the attachment apparatus 119 may be positioned on a top side of the support plate 107. The tooling apparatus 103 and the base plate 105 may be arranged relative to one another such that the fastener 231 and the anchor 251 may be aligned with one of the base openings 111 in the base plate 105. For example, the tooling apparatus 103 may be moved in a downward direction 161 toward the base plate 105, with the downward direction 161 being parallel to an upper surface of the base plate 105.

The base openings 111 in the base plate 105 may have a first opening portion 131 and a second opening portion 133 that are adjacent, and connected, to one another. With the first opening portion 131 and the second opening portion 133 being adjacent and connected to one another, the fastener 231 may move between the first opening portion 131 and the second opening portion 133 by moving in a direction parallel to an upper surface of the base plate 105, such that the fastener 231 may remain within the base opening 111 and need not be removed from the base opening 111. For example, the first opening portion 131 may comprise a larger cross-sectional size, for example, diameter, than a cross-sectional size of the second opening portion 133. For example, the first opening portion 131 may have a first cross-sectional size (e.g., diameter when the first opening portion 131 is circular) that is larger than a second cross-sectional size (e.g., diameter when the second opening portion 133 is circular) of the second opening portion 133. The first and second cross-sectional sizes are selected such that the anchor 251 can pass through the first opening portion 131 but may not pass through the second opening portion 133.

In embodiments, the first opening portion 131 may be sized to receive the anchor 251, for example, with the first opening portion 131 comprising a cross-sectional size that is larger than a cross-sectional size of the anchor 251. As such, the anchor 251 may be inserted through the first opening portion 131. The second opening portion 133 may be joined together with, or continuous with, the first opening portion 131, such that there may not be a wall, barrier, or other obstruction between the first opening portion 131 and the second opening portion 133. The second opening portion 133 may comprise a cross-sectional size that is smaller than a cross-sectional size of the anchor 251. As such, the anchor 251, after being received within the first opening portion 131, may move or slide from the first opening portion 131 to the second opening portion 133. However, when the anchor 251 is received within the second opening portion 133, the anchor 251 is limited or prevented from being inadvertently removed from the second opening portion 133 in a direction parallel to the downward direction 161.

While the foregoing description has been limited to a single attachment apparatus 119 and one of the openings 109, 111, the tool-less assembly 101 is not limited to one attachment apparatus 119. Rather, as illustrated in FIG. 1, the tool-less assembly 101 may comprise a plurality of attachment apparatus 119, for example, two attachment apparatuses 119 that are identical to one another. Likewise, the other openings 109, 111 may be identical to the openings 109, 111 described herein. As such, the other attachment apparatuses 119 and openings 109, 111 may function in an identical manner as the attachment apparatus 119 and openings 109, 111 described herein. For example, to further improve attachment between the tooling apparatus 103 and the base plate 105, a pair of attachment apparatuses 119 may be spaced apart from one another, with both attachment apparatuses 119 configured to engage and attach the tooling apparatus 103 and the base plate 105.

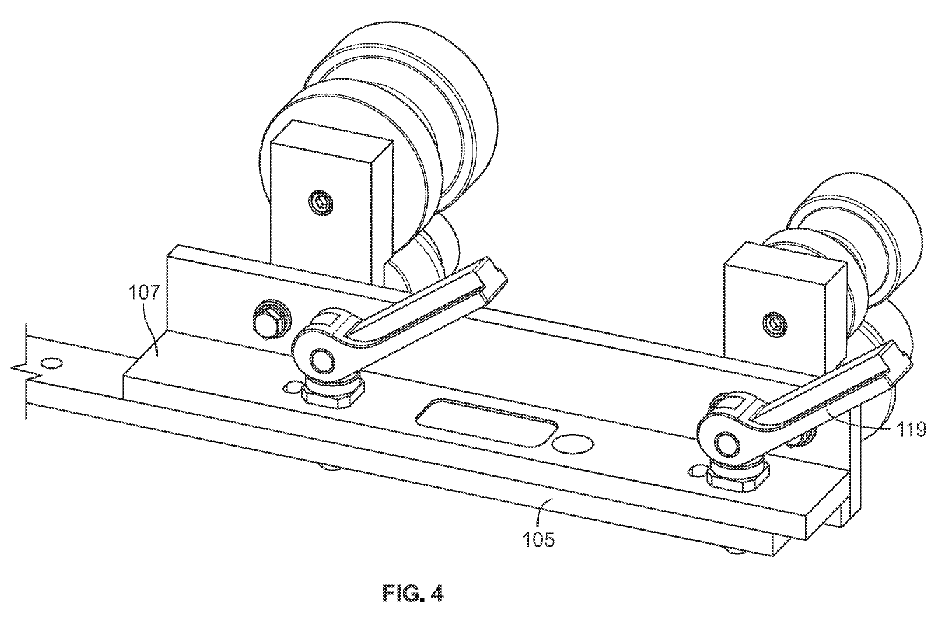

FIG. 4 illustrates the tooling apparatus 103 and the base plate 105 after being moved (e.g., in the downward direction 161) into contact with one another. For example, the base plate 105 may be adjacent to the bottom of the support plate 107. In embodiments, the anchor 251 and the fastener 231 may be inserted into one of the base openings 111 of the base plate 105, for example, by being inserted into the first opening portion 131. As illustrated in FIG. 4, the attachment apparatus 119 may initially remain in the opened or unlocked position after the tooling apparatus 103 has been moved into contact with the base plate 105. As illustrated, the base plate 105 and the support plate 107 may be positioned between the anchor 251, and other portions of the attachment apparatus 119, namely the contact plate 235, the support plate 223, the handle 201.

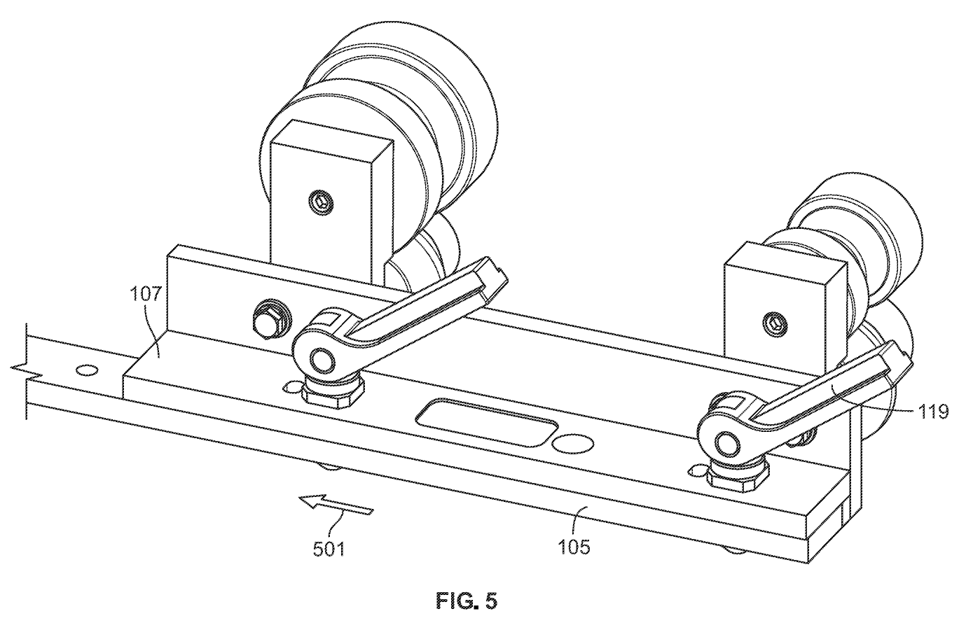

FIG. 5 illustrates the tooling apparatus 103 and the base plate 105 after the tooling apparatus 103 has been slid, or translated, relative to the base plate 105 in a movement direction 501. For example, after the tooling apparatus 103 and the base plate 105 are moved into contact with one another (e.g., illustrated in FIG. 4), the tooling apparatus 103 may be moved in the direction 501 relative to the base plate 105 to cause the anchor 251 and the fastener 231 to move from the first opening portion 131 to the second opening portion 133. For example, as the tooling apparatus 103 is moved in the direction 501, the attachment apparatus 119 may also move in the direction 501 along with the tooling apparatus 103. This movement of the attachment apparatus 119 causes the fastener 231 to move from the first opening portion 131 to the second opening portion 133.

The movement direction 501 may be perpendicular to the downward direction 161 and parallel to an upper surface of the base plate 105. For example, the movement direction 501 may be in a direction from the first opening portion 131 to the second opening portion 133, such that as the tooling apparatus 103 and the attachment apparatus 119 are moved in the movement direction 501, the tooling apparatus 103 and the attachment apparatus 119 may move relative to the base plate 105 which may remain stationary. This relative movement can allow the fastener 231 and the anchor 251 to move relative to the base plate 105 and into the second opening portion 133.

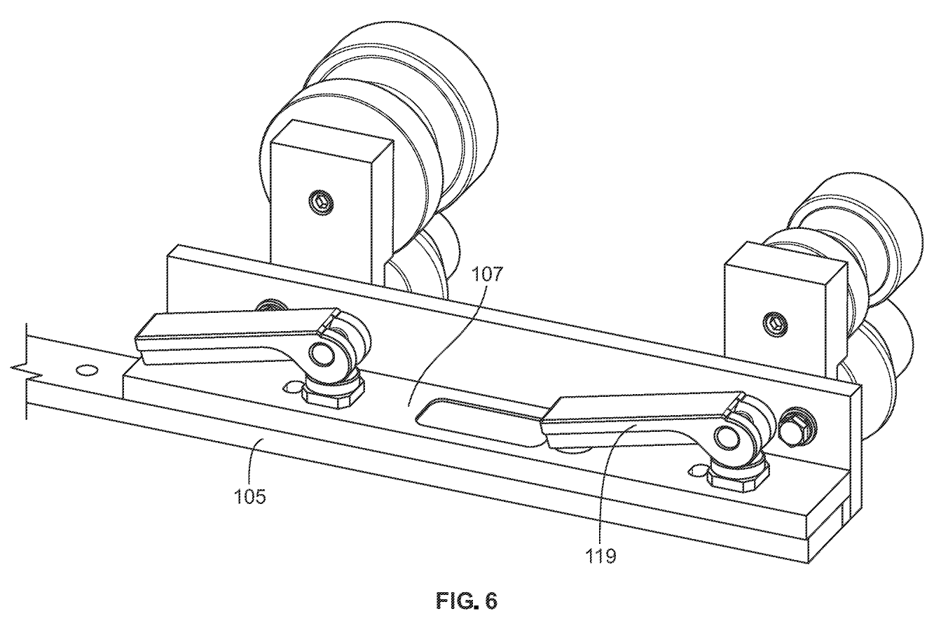

FIG. 6 illustrates the tooling apparatus 103 and the base plate 105 after the handle 201 of the attachment apparatus 119 has been moved from the opened position to the closed position. For example, similar to the embodiments illustrated in FIGS. 2-3, the attachment apparatus 119 may be rotated from the opened position to the closed position, which may cause the anchor 251 to move upwardly toward the base plate 105. The anchor 251 may have a cross-sectional size that is larger than a cross-sectional size of the second opening portion 133, such that the anchor 251 is prevented from passing through the second opening portion 133. Rather, the anchor 251 may contact the bottom of the base plate 105 (e.g., at the location of the bottom of the second opening portion 133) and apply a biasing force to the base plate 105, thus causing the base plate 105 to move toward the tooling apparatus 103. The anchor 251 may apply an upward compressive force to the base plate 105 (e.g., to a bottom surface of the base plate 105) while the contact plate 235 may apply a downward compressive force to the support plate 107 (e.g., to an upper surface of the support plate 107). As such, the attachment apparatus 119 may facilitate an attachment between the tooling apparatus 103 and the base plate 105 by applying a compressive force to the tooling apparatus 103 and the base plate 105, thus limiting the tooling apparatus 103 from becoming inadvertently detached from the base plate 105. Accordingly, the first separating distance may be greater than a combined thickness of the support plate 107 and the base plate 105, while the second separating distance may be equal to a combined thickness of the support plate 107 and the base plate 105.

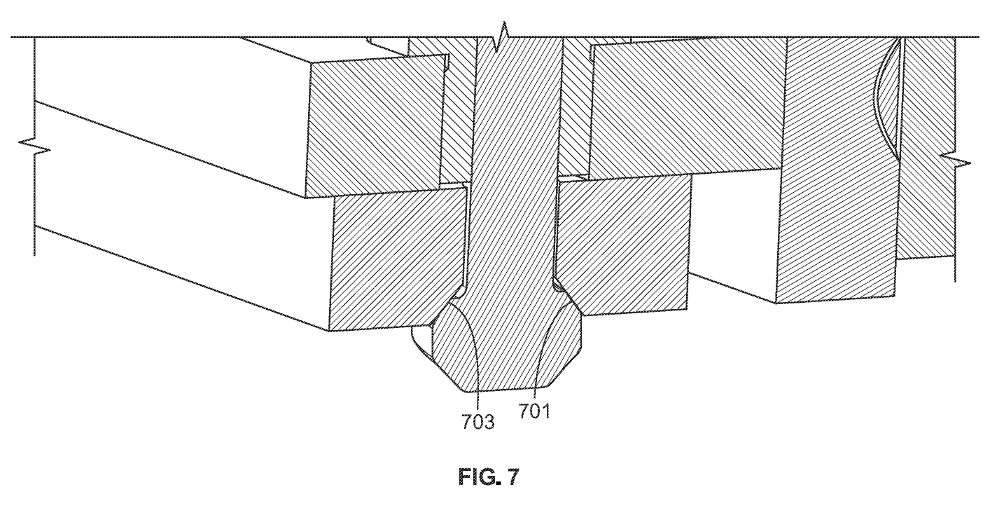

FIG. 7 illustrates a sectional view of the fastener 231 and the anchor 251 in engagement with the base plate 105. For example, the second opening portion 133 may be surrounded by, or defined by, one or more walls 701 that are angled to match a shape of the anchor 251. For example, the anchor 251 may comprise angled sidewalls 703 that contact the angled walls 701 of the base plate 105. Likewise, the second opening portion 133 may be surrounded, or bounded or defined, by the angled walls 701. As such, as the anchor 251 is moved toward the base plate 105 and into contact with the angled walls 701, the angled walls 701 are more likely to hold the anchor 251 and limit the likelihood of inadvertent detachment of the anchor 251 from the base plate 105. In aspects, the angled walls 701 and the angled sidewalls 703 may have substantially matching shapes and angles, for example, with the angled walls 701 being parallel to the angled sidewalls 703. The angled walls 701 can assist in locating and positioning the anchor 251 relative to the base plate 105. Further, the angled walls 701 may limit the anchor 251 from inadvertently sliding from the second opening portion 133 to the first opening portion 131 unless the handle 201 is moved to the opened position.

In aspects, the angled walls 701 and angled sidewalls 703, when in contact with one another, may extend along a wall axis that is angled relative to an elongated fastener axis along which the fastener 231 extends. In aspects, the wall axis may be within a range from 10 degrees to 80 degrees relative to the fastener axis. As such, an upper portion of the anchor 251 may be received within the second opening portion 133, while a lower portion of the anchor 251 may not be received within the second opening portion 133. For example, the bottom surface of the base plate 105 may lie within a plane that intersects the anchor 251, such that an upper portion of the anchor 251 is above the plane and a lower portion of the anchor 251 is below the plane.

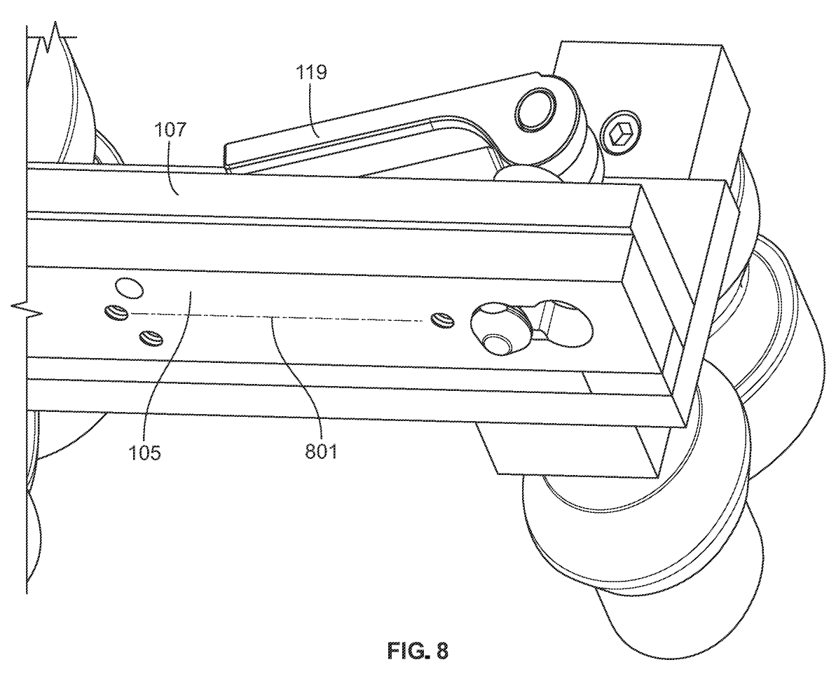

FIG. 8 illustrates a bottom of the base plate 105 while the attachment apparatus 119 attaches the tooling apparatus 103 and the base plate 105. As illustrated, the first opening portion 131 and the second opening portion 133 may be arranged side-by-side such that an axis 801 may pass through the first opening portion 131 and the second opening portion 133, with the axis 801 extending parallel to a bottom surface of the base plate 105. The axis 801 may be perpendicular to the downward direction 161 and may be parallel to the movement direction 501. The axis 801 may be parallel to an elongated length of the base plate 105, wherein the base plate 105 has a maximum dimension (e.g., length) along the axis 801. The anchor 251 comprises a larger cross-sectional size than the fastener 231 and the second opening portion 133, such that the anchor 251 maintains the fastener 231 within the second opening portion 133.

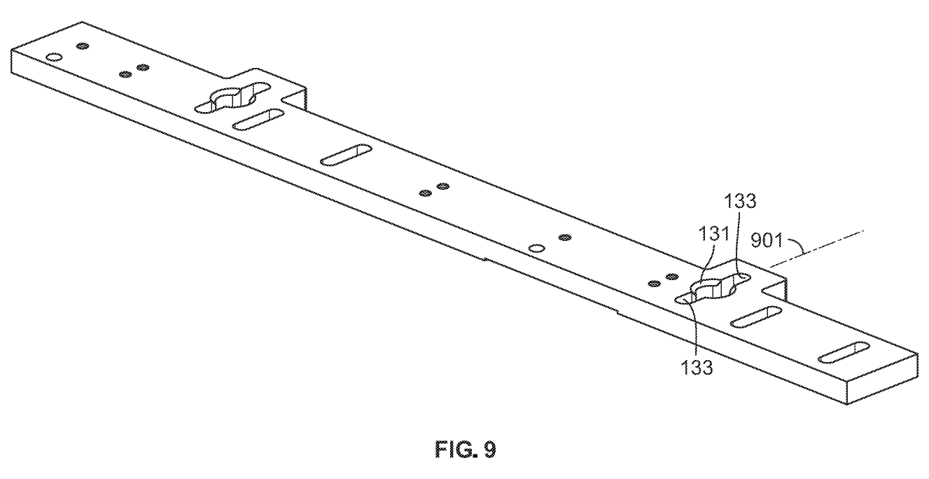

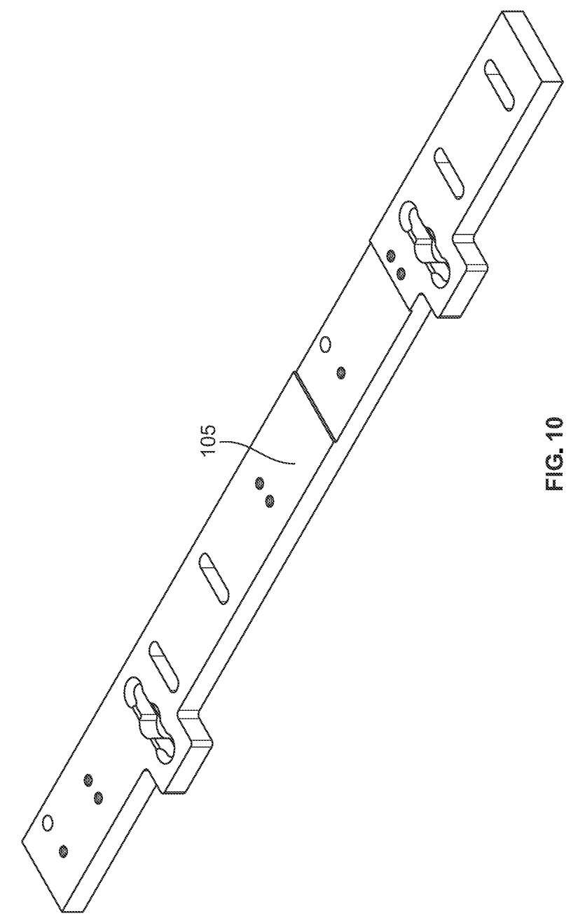

FIGS. 9-10 illustrate an alternative embodiment in which the base opening 111 in the base plate 105 comprises the first opening portion 131, and a pair of second opening portions 133 on opposing sides of the first opening portion 131. In this embodiment, the tooling apparatus 103 and the attachment apparatus 119 are identical to the previous embodiments. Likewise, the base plate 105 is identical to the previous embodiments but for the structure of the base opening 111. For example, the first opening portion 131 may be positioned between one of the second opening portions 133 and another second opening portion 133. As illustrated in FIG. 9, the first opening portion 131, and the pair of second opening portions 133 may be arranged along a second axis 901 that is perpendicular to the axis 801. For example, the second axis 901 may be perpendicular to the downward direction 161 and may be parallel to an upper surface of the base plate 105. In aspects, the second axis 901 may be perpendicular to the elongated length of the base plate 105 (e.g., perpendicular to the maximum dimension, for example, length, of the base plate 105). As such, the tooling apparatus 103 may be moved relative to the base plate 105 in a movement direction 501 that is perpendicular to the movement direction 501 illustrated in FIG. 5.

It should be understood that while various aspects have been described in detail relative to certain illustrative and specific examples thereof, the present disclosure should not be considered limited to such, as numerous modifications and combinations of the disclosed features are possible without departing from the scope of the following claims.

What is claimed is:

1. A tool-less assembly comprising:
a tooling apparatus comprising a support plate defining a support opening that extends through the support plate;
a base plate comprising a base opening that extends through the base plate, wherein the base opening comprises a first opening portion and a second opening portion that are adjacent, and connected, to one another, the first opening portion having a first cross-sectional size that is larger than a second cross-sectional size of the second opening portion; and
an attachment apparatus extending through the support opening and the base opening, the attachment apparatus comprising:
a handle that is configured to move between an opened position and a closed position;
a fastener attached to the handle and extending through the support opening and the base opening; and
an anchor attached to the fastener and having an anchor cross-sectional size that is smaller than the first cross-sectional size and larger than the second cross-sectional size, wherein the support plate and the base plate are positioned between the handle and the anchor with the fastener extending through the second opening portion, and the handle and the anchor configured to apply a compressive force to the support plate and the base plate.

2. The tool-less assembly of claim 1, wherein the fastener is attached to a shaft that is received within the handle, the handle configured to move between the opened position and the closed position by rotating about the shaft.

3. The tool-less assembly of claim 2, wherein the handle comprises an attachment portion that defines a shaft opening into which the shaft is received, the attachment portion comprising a rounded shape that circumferentially surrounds the shaft, the attachment portion comprising:
a first portion that is spaced a first distance in a first radial direction from the shaft; and
a second portion that is spaced a second distance in a second radial direction from the shaft, the second distance greater than the first distance, wherein the second portion is circumferentially offset from the first portion.

4. The tool-less assembly of claim 3, further comprising a contact plate attached to the fastener and positioned between the handle and the anchor, the contact plate configured to move relative to the fastener in a direction toward and away from the anchor, wherein when the handle is in the opened position, the first portion faces the contact plate and the first radial direction is parallel to the fastener such that the contact plate is separated a first separating distance from the anchor.

5. The tool-less assembly of claim 4, wherein when the handle is in the closed position, the second portion faces the contact plate and the second radial direction is parallel to the fastener such that the contact plate is separated a second separating distance from the anchor, wherein the second separating distance is less than the first separating distance.

6. The tool-less assembly of claim 1, wherein the fastener comprises a fastener cross-sectional that is less than the anchor cross-sectional size and less than the second cross-sectional size.

7. The tool-less assembly of claim 1, wherein a bottom of the second opening portion is defined by an angled wall that contacts an angled sidewall of the anchor, and wherein the angled wall and the angled sidewall extend along a wall axis that is angled relative to a fastener axis along which the fastener extends, and wherein the wall axis is within a range from 10 degrees to 80 degrees relative to the fastener axis.

8. The tool-less assembly of claim 7, wherein an upper portion of the anchor is received within the second opening portion such that the anchor is intersected by a plane within which a bottom surface of the base plate lies, the upper portion of the anchor being on one side of the plane and a lower portion of the anchor being on an opposing side of the plane.

9. A tool-less assembly comprising:
a tooling apparatus comprising a support plate defining a support opening that extends through the support plate;
a base plate comprising a base opening that extends through the base plate; and
an attachment apparatus extending through the support opening and the base opening, the attachment apparatus comprising:
a handle that is configured to move between an opened position and a closed position;
a fastener attached to the handle and extending through the support opening and the base opening;
a contact plate configured to move relative to the fastener; and
an anchor attached to the fastener and spaced apart from the contact plate, wherein:
when the handle is in the opened position, the contact plate is separated a first separating distance from the anchor; and
when the handle is in the closed position, the contact plate is separated a second separating distance, which is less than the first separating distance, from the anchor, and the contact plate and the anchor are configured to apply a compressive force to the support plate and the base plate.

10. The tool-less assembly of claim 9, wherein the first separating distance is greater than a combined thickness of the support plate and the base plate.

11. The tool-less assembly of claim 10, wherein the second separating distance is equal to the combined thickness of the support plate and the base plate.

12. The tool-less assembly of claim 11, wherein the anchor is in contact with a bottom surface of the base plate, and the contact plate is in contact with an upper surface of the support plate.

13. A tool-less assembly comprising:
an attachment apparatus configured to attach a tooling apparatus to a base plate by extending through openings in the tooling apparatus and the base plate, the attachment apparatus comprising:
a handle that is configured to move between an opened position and a closed position;
a fastener attached to the handle and extending through the openings in the tooling apparatus and the base plate;
a contact plate configured to move relative to the fastener; and
an anchor attached to the fastener and spaced apart from the contact plate, wherein:
when the handle is in the opened position, the contact plate is separated a first separating distance from the anchor; and
when the handle is in the closed position, the contact plate is separated a second separating distance, which is less than the first separating distance, from the anchor, and the contact plate and the anchor are configured to apply a compressive force to the tooling apparatus and the base plate.

14. The tool-less assembly of claim 13, wherein the attachment apparatus comprises a threaded portion that is configured to engage with, and thread into, a support opening of the tooling apparatus.

15. The tool-less assembly of claim 14, wherein the attachment apparatus comprises a support plate attached to the fastener and positioned between the contact plate and the handle, wherein the support plate and the contact plate are configured to move relative to the fastener.

16. The tool-less assembly of claim 15, wherein the fastener is attached to a shaft that is received within the handle, the handle configured to move between the opened position and the closed position by rotating about the shaft.
